(19) United States
(12) Patent Application Publication
(10) Pub. No.: US 2024/0359428 A1
(43) Pub. Date: Oct. 31, 2024

(54) SYSTEM AND METHOD FOR MANUFACTURING HEMP-BASED BUILDING PRODUCTS AND MATERIALS

(71) Applicant: David Hubbard, Southfield, MA (US)

(72) Inventor: David Hubbard, Southfield, MA (US)

(21) Appl. No.: 18/647,585

(22) Filed: Apr. 26, 2024

Related U.S. Application Data
(60) Provisional application No. 63/498,572, filed on Apr. 27, 2023.

(51) Int. Cl. B32B 9/02; B32B 7/12; B32B 29/00; B32B 37/00

(52) U.S. Cl. CPC B32B 9/02; B32B 7/12; B32B 29/00; B32B 37/0053; B32B 2250/03; B32B 2317/10; B32B 2317/12

(57) ABSTRACT

A method and apparatus for manufacturing a hemp-based building product or material. The method and apparatus include forming a hemp-based multilayer structure, including applying a first solution to a first film layer, applying a hemp strand layer to the first film layer with the first solution, applying a second solution to the hemp strand layer, applying a filler material layer to the hemp strand layer with the second solution, applying a third solution to the filler material layer, and applying a second film layer to the filler material layer with the third solution. The method and apparatus also include pressing the formed hemp-based multilayer structure and heating the formed hemp-based multilayer structure.

### CROSS-REFERENCE TO RELATED APPLICATION

This application claims priority to and the benefit of provisional U.S. Patent Application No. 63/498,572, titled “System and Method for Manufacturing Hemp-Based Building Products and Materials,” filed Apr. 27, 2023, which is hereby incorporated herein by reference in its entirety.

### FIELD OF THE DISCLOSURE

The present disclosure relates to a system, a method, and a computer program for manufacturing building products and materials comprising multiple layers of hemp.

### BACKGROUND OF THE DISCLOSURE

The building industry uses engineered wood for a variety of construction purposes in commercial, industrial and residential applications. Engineered wood is typically made by binding pieces of wood and wood byproducts, such as, for example, scrap wood, shredded wood, or sawdust, with resins to produce wood-based products that can be stronger and more durable than the actual wood from which the products are derived. For instance, plywood is a material manufactured from multiple layers of wood that are bound together using resins to form a planar board, such as, for example, medium-density fiberboard (MDF), oriented standard board (OSB), or particle board.

As demand for wood-based building products and materials increases, so too do the resultant negative effects on the environment. There exists an unmet need for an alternative to wood-based building products and materials.

### SUMMARY OF THE DISCLOSURE

The disclosure provides a solution that can provide an alternative to wood-based building products and materials. In particular, the disclosure provides a system, a method, and computer-readable medium comprising executable computer code for manufacturing hemp-based building products and materials.

In various embodiments, the system includes a strandsitioner, a blender, a heated or unheated hydraulic or roller press, and one or more conveyors. The system can include a controller configured to operate any of the computing resources in the system.

A method is provided for manufacturing a hemp-based building product or material. In various embodiments, the method comprises forming a hemp-based multilayer structure, including: applying a first solution to a first film layer; applying a hemp strand layer to the first film layer with the first solution; applying a second solution to the hemp strand layer; applying a filler material layer to the hemp strand layer with the second solution; applying a third solution to the filler material layer; and applying a second film layer to the filler material layer with the third solution. The method further comprises pressing the formed hemp-based multilayer structure and heating the formed hemp-based multilayer structure.

In the method: at least one of the first film layer and the second film layer can comprise a vinyl polymer or a paper layer; or at least one additional filler material layer can be applied before applying the second film layer; or at least one additional hemp strand layer can be applied, which can comprise hemp fiber strands oriented at an angle with respect to hemp fiber strands in the hemp strand layer. The angle can be about 90-degrees.

In the method: the first solution can comprise a tacky solution; or the second solution can comprise an adhesive solution; or the third solution can comprise an adhesive solution. The method adhesive solution can comprise a bioadhesive.

An apparatus is provided for manufacturing a hemp-based building product or material. In various embodiments, the apparatus comprises: a first material supply unit configured to supply a first film layer; a second material supply unit configured to supply a hemp strand layer and position the hemp strand layer on the first film layer; a third material supply unit configured to supply a filler material layer and position the filler material layer on the hemp strand layer; a fourth material supply unit configured to supply a second film layer and position the second film layer on the filler material layer; and a press configured to receive and apply a pressure to the first film layer, the hemp strand layer, the filler material layer, and the second film layer, wherein the press is further configured to heat the first film layer, the hemp strand layer, the filler material layer, and the second film layer. In an embodiment, the apparatus can comprise: a first applicator unit configured to apply a first solution to the first film layer; a second applicator unit configured to apply a second solution to the hemp strand layer; and a third applicator unit configured to apply a third solution to the filler material layer.

In the apparatus: the press can include at least one of a pressure plate and a plurality of rollers; at least one of the first film layer and the second film layer can comprise a vinyl polymer or a paper layer; the first solution can comprise a tacky solution; the second solution or the third solution can comprise an adhesive solution; and the adhesive solution can comprise a bioadhesive.

The apparatus can further include at least one additional material supply unit that is configured to supply an additional hemp strand layer and position the additional hemp strand layer on said hemp strand layer or the filler material layer. The at least one additional material supply unit can comprise a material supply unit that is configured to supply an additional filler material layer and position the additional filler material layer on the additional hemp strand layer. The additional hemp strand layer can comprise hemp fiber strands oriented at an angle with respect to hemp fiber strands in said hemp strand layer. The angle can be about 90-degrees.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a block diagram of an embodiment of an apparatus for manufacturing a hemp-based building product.

FIG. 2 shows a block diagram of an embodiment of an aggregator that can be included in the apparatus constructed according to the principles of the disclosure.

FIG. 3 shows a block diagram of another embodiment of the apparatus for manufacturing a hemp-based building product.

FIG. 4 shows a block diagram of another embodiment of the aggregator.

FIG. 5 shows a block diagram of a further embodiment of an apparatus for manufacturing a hemp-based building product.

FIG. 6 shows a block diagram of an embodiment of a controller that can be included in the apparatus constructed according to the principles of the disclosure.

FIG. 7 shows a block diagram of an embodiment of a manufacturing process that can be performed by the apparatus constructed according to the principles of the disclosure.

FIG. 8 shows a nonlimiting example of a hemp-based building product that can be produced by the apparatus, constructed according to the principles of the disclosure.

FIG. 9 shows a cross-section cut view of a nonlimiting example of the product in FIG. 8.

FIG. 10 shows a nonlimiting embodiment of a hemp material supply unit that can be included in an embodiment of the apparatus of FIG. 5.

The present disclosure is further described in the detailed description that follows.

### DETAILED DESCRIPTION OF THE DISCLOSURE

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

Cannabis sativa cultivars can be grown and harvested as hemp. Hemp is a botanical class of Cannabis sativa cultivars that is among the fastest growing plants on the planet. It is classified under the green category due to its positive effects on the environment, including weed growth suppression, anti-erosion, reclamation properties, and its ability to remove poisonous substances and heavy metals from soil. Hemp can yield three to four times more usable fiber per square foot per annum than trees; and hemp stalks can reach maturity in about three to four months, whereas trees can take from twenty to eighty years, or more. Hemp fiber is one of the strongest and most durable natural fibers in the world.

The use of wood in building products and materials has contributed to deforestation and the earth's diminishing supply of wild timber resources, thereby presenting major environmental and ecological concerns. The solution disclosed herein provides an alternative to wood in building products and materials.

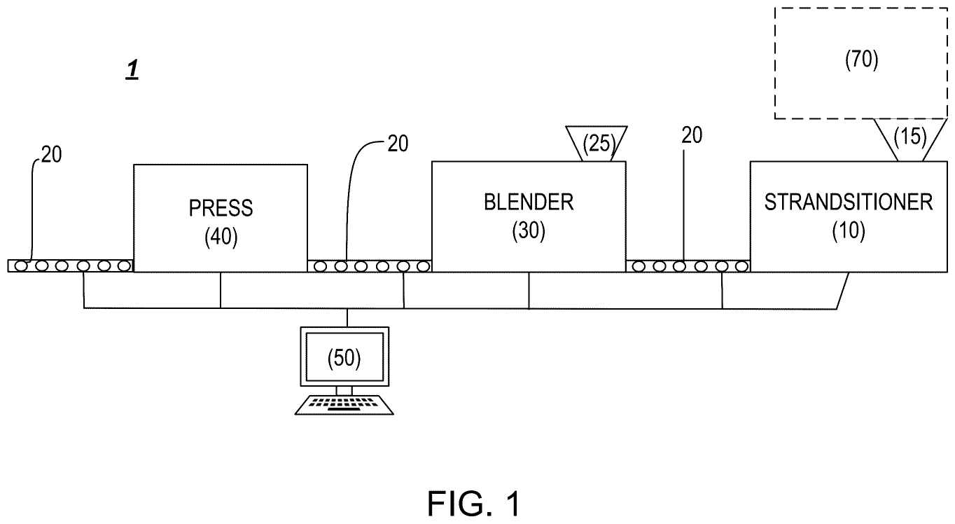

FIG. 1 shows a block diagram of an embodiment of an apparatus 1 for manufacturing hemp-based building products and materials, according to the principles of the disclosure. In this embodiment, the apparatus 1 includes a strandsitioner 10, a conveyor 20, a blender 30, and a press 40. In at least one embodiment, the apparatus 1 includes a controller 50, which can be communicatively coupled to any or more of the conveyor 20, the strandsitioner 10, the blender 30, and the press 40. The apparatus 1 can include a compression unit 70.

The conveyor 20 can include a conveyor section located at an input or an output of any one or more of the strandsitioner 10, the blender 30, the press 40, and the compression unit 70. In certain embodiments, the conveyor 20 can include a conveyor section located in the strandsitioner 10, the blend 30, the press 40, or the compression unit 70. The conveyor 20 can include a plurality of conveyor sections that are connectable to form a conveyor line that receives strands of hemp in the strandsitioner 10 (or hemp stalks in the compression unit 70) and transports the hemp through the apparatus 1, including through the blender 30 and the press 40.

In various embodiments, the conveyor 20 includes one or more conveyor drivers (not shown). Each conveyor driver (not shown) can include a motor, a shaft, one or more rollers, one or more chains, one or more gears, and a power source. The conveyor 20 can include one or more conveyor belts. The conveyor 20 can include one or more rollers. The one or more conveyor belts can be supported by the one or more rollers, or by a substantially frictionless surface. The conveyor 20 is configured to move articles, including, for example, hemp, through various sections of the process/system. In at least one embodiment, each section of the conveyor 20 can be controlled individually, such as, for example, to operate at a unique velocity (including rate of speed and direction) that can differ from that of any other section in the conveyor 20.

In the embodiment depicted in FIG. 1, the conveyor 20 includes at least three conveyor sections, each having a belt wound around a plurality of rollers, at least one of which can be driven by a motor (not shown) to move the belt by means of, for example, a sprocket and chain combination or a driver roll, as will be understood by those skilled in the art. The conveyor 20 includes a conveyor section located between an output of the strandsitioner 10 and an input of the blender 30, a conveyor section located between an output of the blender 30 and an input of the press 40, and a conveyor section located at an output of the press 40. The conveyor section located at the output of the press 40 can be configured to transport and deliver a hemp-based product from the press 40 to a finishing process (not shown), a transport vehicle (not shown), or another process (not shown) as will be understood by those skilled in the art.

The strandsitioner 10 can include an input 15 configured to receive the hemp from a supply source (for example, a hemp roller, shown in FIG. 3). The supply source can include, for example, a conveyor section (not shown) and/or the compression unit 70, configured to shred and/or compress hemp stalks and supply resized hemp. In an embodiment, the strandsitioner 10 includes the compression unit 70. The strandsitioner 10 can be configured to receive a material, such as, for example, hemp, and resize, reshape, align, and position the resized/reshaped and aligned/realigned material on the conveyor 20. The strandsitioner 10 can be configured to resize and/or reshape hemp stalk into strands of hemp and align the strands along a particular direction (for example, travel direction of the conveyor 20) before placing (or as it places) the strands of hemp on the conveyor 20, or any intermediate material placed between the conveyor 20 and strands.

In various embodiments, the strandsitioner 10 can include a shredder device such as, for example, an LRK shredder made by UNTHA, for example, an LRK 700, LRK 1000, LRK 1400, or the like.

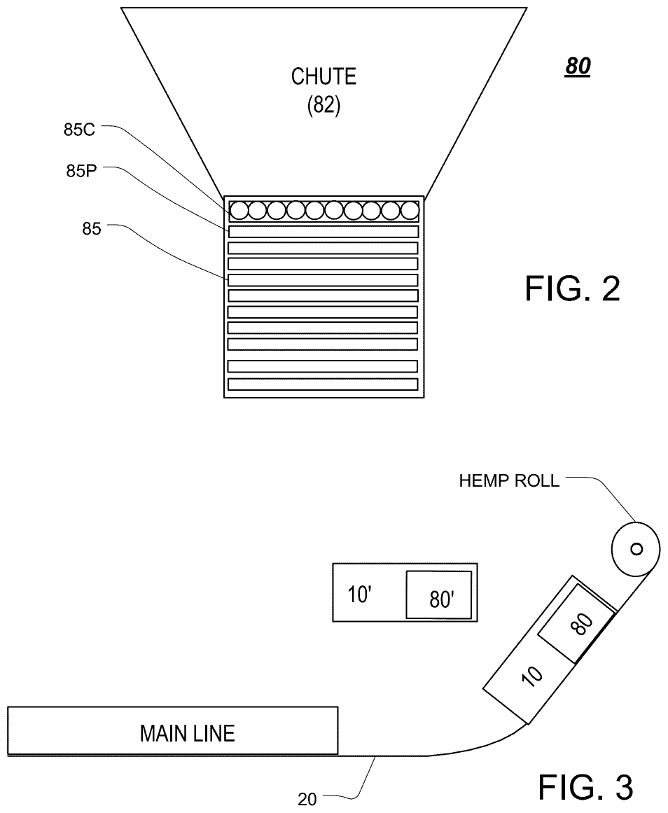

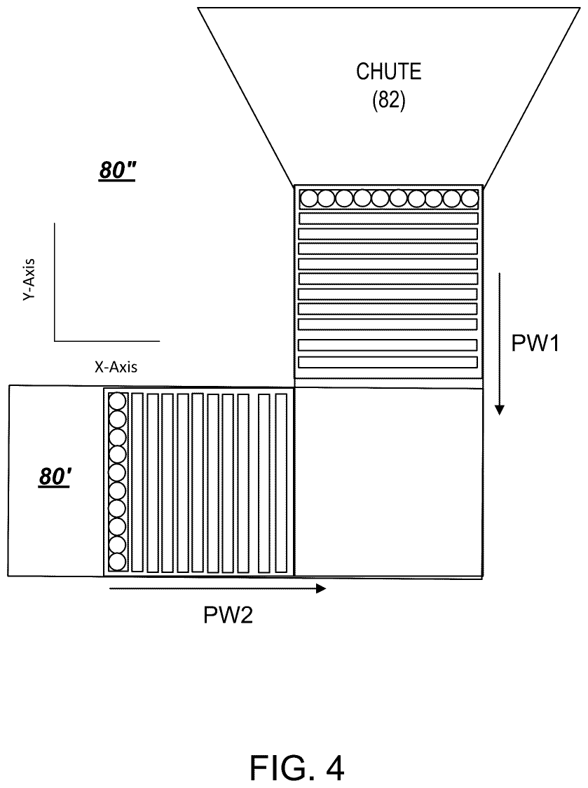

In various embodiments, the compression unit 70 can include one or more aggregators 80/80′ (shown in FIGS. 2 and 4).

One of the problems with state-of-the art machinery is that it cannot accept full length stalks of raw materials such as hemp. The raw materials are typically too long and too fluffy to be received by such machinery, thereby necessitating that the stalks be cut and processed prior to feeding to the machine. The strandsitioner 10 can be configured to receive full-length hemp stalks and resize and/or reshape them to dimensions that can be processed easily by the apparatus 1. The strandsitioner 10 can include the compression unit 70, which can be configured to reshape (for example, compresses) and resize hemp multi-dimensionally, including in multiple planes that are perpendicular to each other, such as, for example, in the x-y plane, x-z plane, and/or y-x plane in the Cartesian coordinate system.

In an embodiment, the strandsitioner 10 can include a cutting unit that cuts and sizes full-length stalks to one or more predetermined sizes, including, for example, one or more predetermined lengths, widths, thicknesses, or weights. The cutting unit can be positioned upstream of an aggregator 80 (shown in FIGS. 2-3).

In an embodiment, the strandsitioner 10 can include a spinning roller with or without teeth that grab the hemp and move it downstream. It does not cut the hemp or weave it into a strand

In an embodiment, the compression unit 70 includes an aggregator 80 (shown in FIG. 2) or aggregator 80″ (shown in FIG. 4), which can include one or more optional cutting rollers 85C.

In various embodiments, the compression unit 70 comprising the aggregator 80 (shown in FIG. 2) can be configured such that the chute 82 compresses hemp multi-dimensionally to resize the hemp from, for example, 5 feet to, for example, 4 feet wide, with a thickness of about 5 inches. In at least one embodiment, the hemp can be allowed to remain fluffy when reduced in size to, for example, the 5-inch thickness. It is noted that other dimensions are contemplated, including chute input dimensions wider (or narrower) than 5 feet and thicker (or thinner) than 1 foot, and chute output dimensions narrower (or wider) than 4 feet and thinner (or thicker) than 5 inches.

The strandsitioner 10 can be configured to receive the resized hemp from the supply source via the input 15 and cut the hemp into strands that are, for example, a predetermined length that is between about 1 in. and about 8 in. long, a predetermined width that is between about 0.1 in. and 1.5 in. wide, and a predetermined thickness that is between about 0.01 in. to about 0.5 in. thick. It is noted that other hemp strand dimensions are contemplated herein, including hemp strands that are shorter than 1 in. or longer than 8 in., narrower than 0.1 in. or wider than 1.5 in., and thinner than 0.01 in. or thicker than 0.5 in.

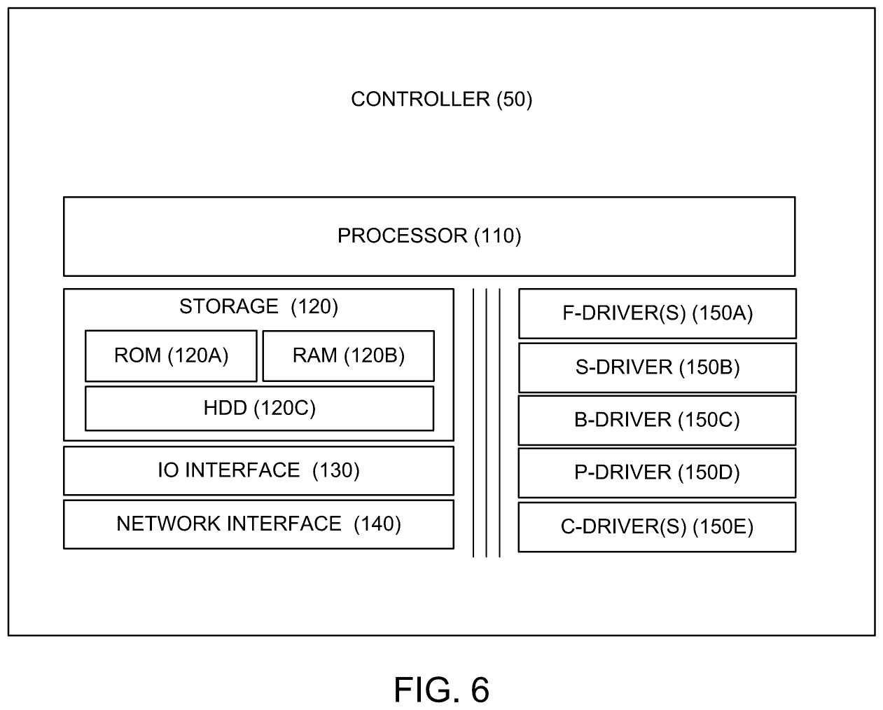

The input 15 can include a top-mount or a side-mount hopper. The hemp supply source can be configured to communicate with a dedicated driver in the controller 50, such as, for example, a feed driver (F-DRIVER) 150A, seen in FIG. 6, and provision the hemp (for example, hemp stalks or resized hemp) to the input 15.

FIG. 2 shows a nonlimiting embodiment of the aggregator 80, which can be included in the strandsitioner 10 and/or the compression unit 70. The aggregator 80 can include a chute 82 having at least one adjustable inner wall (for example, two, three, or four adjustable inner walls) configured to guide and size the hemp as it travels downstream in the aggregator 80. The aggregator 80 can include one or more rollers 85, each of which can be configured to apply pressure to the hemp (for example, hemp stalks or resized hemp strands). The roller(s) 85 can include one or more cutting rollers 85C, which can be configured to cut the hemp as it travels downstream, and one or more compressing rollers 85P, which can be configured to compress the hemp as it travels downstream.

In an alternative embodiment, the cutting roller(s) 85C and/or compressing roller(s) 85P can be located upstream of the chute 82, so as to compress and/or cut the hemp before it is input to the chute 82. In this embodiment, the roller(s) 85 is (are) dimensioned to have a width substantially equal to the width of the upstream opening of the chute 82, so that all hemp undergoes processing by the roller(s) 85 before entering the chute 82.

In an embodiment in which the strandsitioner 10 comprises the aggregator 80 (for example, shown in FIG. 3), the hemp can be received from a supply source such as a roll of hemp or full-length hemp stalks. The received hemp can be received at an input of the chute 82 (or the roller(s) 85 in an alternative embodiment), and as the hemp travels downstream, the inner walls of the chute 82 can be configured to taper the hemp pathway to compress the hemp width-wise or height-wise, or multidimensionally width- and height-wise, including along a horizontal plane (for example, along the width of the chute 82) plane and along a vertical plane (for example, along the height of the chute 82).

In various embodiments, at least one inner wall of the chute 82 is configured to be adjustable in height and/or width so as to change the dimensions (for example, width and/or height) of the hemp pathway in the chute 82. The chute 82 can be configured to be wider (for example, 4 ft., 5 ft., 6 ft. or greater width) and taller (for example, greater than 12 in. high) at the upstream opening than the downstream opening, which can be configured to be, for example, about 4 ft. wide (or less) and about 6 in. high (or less). Other dimensions are contemplated for the upstream and downstream openings, depending on the size of the desired product, the shape and size of the hemp fed into the apparatus.

The apparatus 1 can include a hemp bale and angled slide, as seen in FIG. 3, wherein the hemp bale feeds hemp to the angled slide, which then guides the hemp downstream as it slides to the strandsitioner 10, or, in certain embodiments, the compression unit 70 or the aggregator 80, including the chute 82 and downstream rollers 85.

In another embodiment, another feed line, including a strandsitioner 10′ with aggregator 80′ can be included in the apparatus 1. The additional feed line can be configured to supply and overlap hemp strands that are perpendicular in direction to the hemp strands on the first (or main) feed line of the apparatus 1. The second feed line can include the same (or a different) hemp bale, angled-slide, strandsitioner 10′ and aggregator 80′ combination as the first feed line. The angle of the slide can be configured to be, for example, 15-degrees, 30-degrees, 45-degrees, or greater with respect to the plane of the floor (not shown) on which the assembly is seated. Other angles are contemplated, including less than 15-degrees and greater than 45-degrees, as well as any angle within such range.

The adjustable sides of the chute 82 can be configured to engage and direct stalks as they travel downstream along the chute 82. In at least one embodiment, a plurality of the rollers 85 can be positioned inside walls of the chute 82, on each side so that the compressed material does not squeeze out the sides.

The rollers 85 can include one or more compression rollers 85P positioned at a downstream end of the aggregator 80 and configured to squeeze (or compress) the hemp in the vertical plane as it travels downstream in the aggregator 80, compressing the height of the hemp from, for example, 6 in. or greater, down to, for example, ⅛ in., ¼ in., ⅓ in., ½, in., ¾ in., or any other predetermined height that is less than the height of the hemp entering the compression zone, which is comprised by the at least one compression roller 85P.

In various embodiments, the cutting rollers 85C can be optionally included in the aggregator 80 (80′).

In an embodiment, the rollers 85 include a plurality of compression rollers 85P, including an upstream-most compression roller 85P that is positioned at a greater distance from the surface on which the hemp travels (for example, 6 in.) than any of the subsequent, downstream compression rollers 85P; and, the downstream-most compression roller 85P is positioned at the shortest distance from the surface and configured to compress the hemp as it travels downstream to the aforementioned predetermined height.

In various embodiments, the rollers 85 can be configured to be adjustable to change the spacing between each compression roller 85P (and/or cutting roller 85C) and the surface on which the hemp travels inside the aggregator 80.

The rollers 85 can be configured to have different or the same temperature application. For example, the upstream compression roller(s) 85P can be configured to heat and apply a greater temperature to the hemp than the downstream compression roller(s) 85P. Alternatively, the temperature can be the same for all (or fewer than all) rollers 85, such as, for example, all of the rollers 85 kept at room temperature or heated (or cooled) to a predetermined temperate greater or less than room temperature.

In certain embodiments, one or more of the rollers 85 can be included in the housing of the chute 82. In other embodiments, the rollers 85 can be positioned separate from the chute 82 housing and located downstream (or upstream) of the chute housing.

In the case of the aggregator 80 included in the strandsitioner 10, full-length hemp stalks or resized hemp can be received from the supply source (such as, for example, the compression unit 70). As the hemp travels downstream through the chute 82, the hemp is compressed in the horizontal and/or vertical planes by the inner walls of the chute, which can be adjusted in height and/or width so as to change the dimensions (for example, width and/or height) of the hemp pathway in the chute 82. The chute 82 inner walls can be configured to align and direct strands of the hemp as it moves downstream in the aggregator 80.

In an embodiment, the chute 82 in the aggregator 80 receives stalks of hemp and compresses the stalks horizontally and/or vertically. The compressed stalks move downstream to the cutting rollers 85C, where the stalks are resized to one or more predetermined dimensions (for example, length, width, and thickness) before being compressed by the compression rollers 85P, after which the compressed, resized strands can be output to the strandsitioner 10, such as, for example, via the input 15.

In various embodiments of the aggregator 80, the rollers 85 can include one or more hydraulic-operated rollers, motor-driven rollers, free-spinning rollers, heated rollers, or the like. In various embodiments, the hemp naturally produces an overlapping and tangled set of strands. While it may not be necessary to reconfigure the natural structure of the plant, certain embodiments can necessitate positioning the strands at 90-degrees to each other for added strength. In this regard, the strands can be positioned at, for example, about 90-degrees to each other by having at least one separate feed line that produces and places mats of hemp strands on top of the continuous feed line. It is noted that other angles of cross-linking are contemplated, including, for example, an angle between 10-degrees and 80-degrees, or an angle between 30-degrees and 60-degrees, or an angle between 45-degrees and 75-degrees.

FIG. 4 shows a non-limiting embodiment of multipath aggregator 80″ that includes 90-degree offset hemp pathways PW1 and PW2 for cross-weaving hemp fiber strands for added strength. The offset hemp pathways PW1 and PW2 are offset by about 90-degrees in the horizontal X-Y plane and also offset vertically along the Z-axis such that hemp fiber strands traveling along the pathway PW2 are dropped vertically onto hemp fiber strands traveling along the pathway PW1, thereby crisscrossing the fiber strands. The X, Y, Z are axes of the Cartesian coordinate system.

In various embodiments, along with other components of the apparatus 1, the strandsitioner 10, compression unit 70 and/or the aggregators 80, 80″ can be configured to operate under the control of controller 50.

FIG. 3 shows an alternative embodiment of the apparatus 1, in which the apparatus includes a second line that is 90-degree offset from the main line. In this embodiment, the strandsitioner 10′ is offset both horizontally and vertically with respect to the main line. The second line, including the strandsitioner 10′, is configured to direct and layer hemp fiber strands at 90-degrees and on top of the hemp fiber strands in the main line, for example, as the main line hemp strands are output from the strandsitioner 10. The strandsitioner 10′ can include the aggregator 80′.

In certain embodiments, the apparatus 1 can be configured with, or connected via a conveyor 20 to, one or more immersion tanks (not shown), each of which can be configured to receive hemp strands and hold them in a solution until the hemp is saturated. In such embodiments, the apparatus 1 can also include a drying station (not shown) that is configured to receive and treated hemp strands and dry the strands thoroughly. In an embodiment, the hemp strands can be transported between the tanks, the drying station, and the strandsitioner 10 or blender 30 via one or more conveyor sections. The treated and dried hemp strands can be transported, for example, via the conveyor 20, from the drying station to the strandsitioner 10 or the blender 30. The solution can include a bioadhesive, or it can include a treatment solution that facilitates separation of the fibrous hemp by the strandsitioner 10 into pieces or strands of fibers of predetermined size and shape.

Referring to FIG. 1, the blender 30 can be configured to apply a solution to the hemp strands. The hemp fiber strands can be transported from the strandsitioner 10 to the blender 30 by means of the conveyor 20. The blender 30 can include an input configured to receive the hemp fiber strands transported by the conveyor 20.

The blender 30 can include a blend processor (not shown) and an input 25 that is configured to receive resins from a resin supply source (not shown). The blend processor and resin supply source can be configured to operate under control of the controller 50, including the speed, rate, and amount of resin material that is supplied to (via the input 25) and processed by the blend processor, including individualized control of speed, rate, and amount of resin at each application stage.

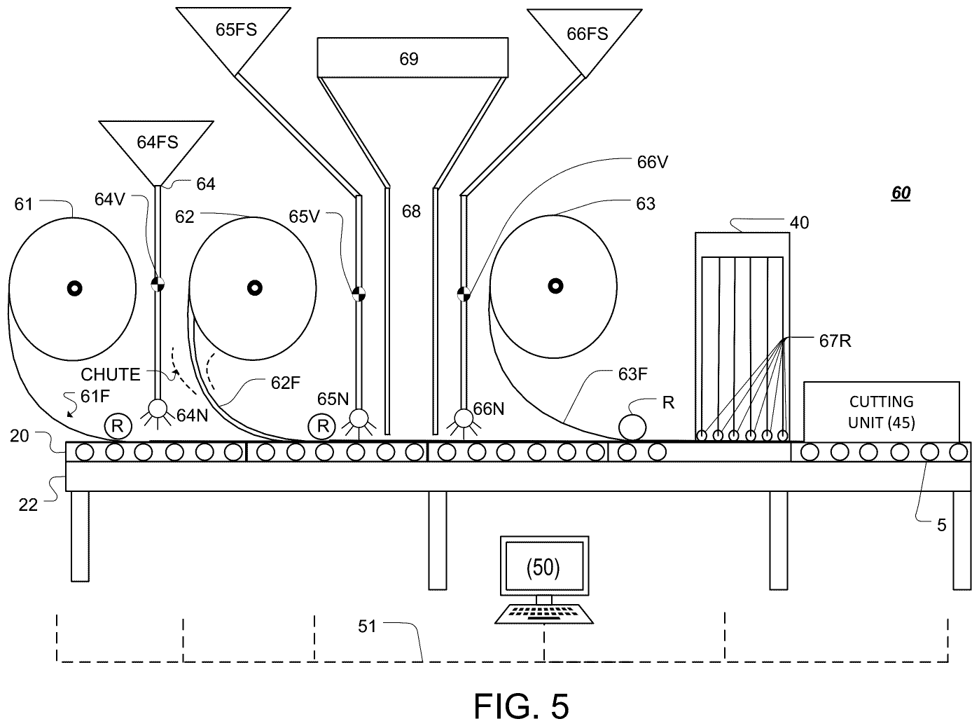

In at least one embodiment, the blender 30 can include any one or more of the components R, 62, 62F, 63, 63F, 64, 64FS, 64V, 64N, 65, 65FS, 65V, 65N, 66, 66FS, 66V, 66N, 68, or 69, shown in FIG. 5, and discussed below.

In various embodiments, the input 25 can include a top-mount hopper, a side-mount hopper, a conveyor, or a conduit such as, for example, a cylindrical tube. The input 25 can be configured to receive a resin material such as, for example, resin pellets, resin powder, or resin liquid, from the resin supply source and feed the material into the blend processor.

The blend processor (not shown) can include a heating unit (not shown) configured to melt the resin material and a forming unit (not shown) configured to apply the melted resin material to the hemp fiber strands. The blend processor can include a mixing unit (not shown).

In certain embodiments, the blender 30 can be configured to layer hemp fiber strands in multiple layers and apply resin material to the hemp fiber strands, including, for example, between layers and within each layer of hemp fiber strands.

In an embodiment, the blender 30 can be configured to orient and layer the hemp fiber strands in perpendicularly alternating directions such that each layer of hemp fiber strands is positioned normal (90°) to each adjacent layer of hemp fiber strands. In an embodiment, the blender 30 can be configured to interweave fiber strands of different layers together for further added strength.

In at least one embodiment, the strandsitioner 10 and blender 30 can be integrated into a single device and configured to perform the operations of the strandsitioner and 10 and the blender 30.

Compared to layers of hemp fiber strands that are, for example, parallelly oriented, the cross-orienting and/or weaving of the hemp fiber strand layers can significantly increase strength and durability of the building product or material output at the press 40.

In various embodiments, the blender 30 can be configured to operate under the control of the controller 50 to (continuously or intermittently) output multilayered hemp fiber strands blended with resin and, in some embodiments, other materials such as, for example, fiberglass, recyclables, wood, metal, plastics, or the like.

In an embodiment, the blender 30 can be configured to receive control signals from the blend driver (B-DRIVER) 150C, seen in FIG. 6, which can be configured to send control signals to the blender 30 (or the strandsitioner 10 comprising the multipath aggregator 80″, shown in FIG. 4) to position and layer hemp fiber strands in a plurality of layers at a determined speed, rate, or direction, and to apply the resin to the hemp fiber strands. The B-DRIVER 150C can be configured to send control signals to the blender 30 to orient the hemp fiber strands in a particular direction, or in different directions for each layer of hemp fiber strands.

The multilayered blended hemp fiber strands can be transported from the blender 30 to the press 40 by means of the conveyor 20. The press 40 can include an input configured to receive the multilayered blended hemp fiber strands transported by the conveyor 20. The press 40 can include, for example, rollers, a heat tunnel, one or more pressure plates, or any combination thereof.

In various embodiments, the press 40 can include one or more rollers or a pair of opposing planar plates (not shown) that are configured to receive the multilayered blended hemp fiber strands and, with the multilayered blended hemp fiber strands located therebetween, press the multilayered blended hemp fiber strands to form a solid structure. In certain embodiments, the press 40 can include a plurality of pair-sets of opposing planar plates arranged in parallel (or in series) and configured to speed up the line velocity by providing continuous feed and operation, since the line need not wait for a particular plate pair to be cleared, but, rather, the feed can be diverted to the another plate pair such that there is no down time. In at least one embodiment, the pair-sets can be arranged to operate at different times such that as one pair-set presses the multilayered blended hemp fiber strands, another pair-set opens to receive the next multilayered blended hemp fiber strands.

In certain embodiments, one or more rollers, a heat tunnel, or one or both of the plates can include a heating unit that applies heat to the multilayered blended hemp fiber strands for curing while applying pressure. The heat curing can be configured to harden the pressed, multilayered blended hemp fiber strands by facilitating the cross-linking of, for example, polymer chains.

In various embodiments, the press 40 can include a plurality of rollers or pair-sets of plates, with the last set of rollers or pair-sets of plates configured to apply only pressure, without applying heat. The apparatus 1 can be configured such that the bioadhesive can cure under pressure, for example, after the heat acts on the bioadhesive.

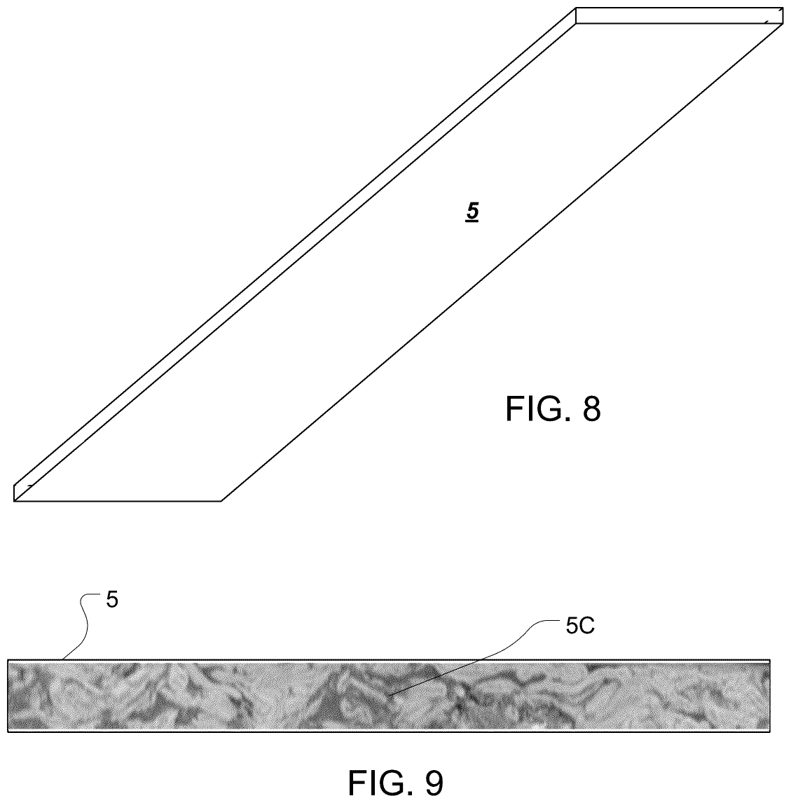

In various embodiments, the press 40 can include one or more cutting blades to cut the formed structure to a predetermined shape and size, including width, height, and length, such as, for example, the product depicted in FIGS. 8 and 9. For example, the cutting blades can be configured to cut the formed structure into building panels, building boards, building beams, building studs, furniture pieces, or the like.

The press 40 can be configured to operate under control of the controller 50, including the speed, rate, and amount of pressure, as well as the temperature, applied in each section of the system/process, including that which is applied to the multilayered blended hemp fiber strands to form the solid structure, as well as the cutting dimensions for the formed structure. In an embodiment, the press 40 can be configured to receive control signals from a press driver (P-DRIVER) 150D in the controller 50, seen in FIG. 6.

After the structure has been formed and cut to the predetermined shape and dimensions, it can be output by the press 40 to the conveyor 20 to be transported to a finishing stage (not shown), a delivery vehicle (not shown), or another process (not shown).

The controller 50 includes a computing device (shown in FIG. 6) that can be communicatively coupled via a transceiver (not shown) and one or more communication links to any, or all, of the strandsitioner 10, the conveyor 20, the blender 30, the press 40, the compression unit 70, and the aggregator 80 (or 80′ or 80″). The controller 50 can be communicatively coupled to one or more material supply sources or fluid supply sources (including, for example, fluid supply sources 64FS, 65FS, 66FS shown in FIG. 5, and the hemp roll shown in FIG. 3) that feed fluids and/or materials into the apparatus 1, including, for example, bioadhesives, biocomposites, hemp stalks, hemp strands, resin pellets, resin powder, resin liquid, fiberglass, plastics, bioplastics, recyclables, or other materials.

FIG. 5 shows another embodiment of the apparatus 1, which comprises the conveyor 20, a plurality of film material supply rolls 61, 63, a hemp supply roll 62, a plurality of fluid applicators 64N, 65N, 66N, a plurality of valves 64V, 65V, 66V, a plurality of fluid sources 64FS, 65FS, 66FS, a plurality of rollers R, the press 40, a chute 68, and the controller 50, which can be communicatively coupled to each of the foregoing via one or more communication links 51 to control operations thereof.

In at least one embodiment, the film material supply roll 61 can be replaced by the strandsitioner 10 (shown in FIG. 1). In this regard, the strandsitioner 10 can be configured to receive, reshape, resize, and/or align/realign hemp into a continuous sheet of hemp, for example, 4 feet wide and 6 inches thick before feeding the resultant hemp sheet as continuous hemp sheet 61F to roller R, in FIG. 5.

In alternative embodiments, the apparatus 1 can include one or more additional film material supply rolls 61 or 63, and/or one or more additional hemp supply rolls 62, so as to make a multilayer product, including, example, a structure having two, three, four, or more layers of hemp 62F sandwiched between multiple layers of film 61F and/or 63F.

The conveyor 20 can be supported by a support 22, which can be configured to support a single continuous conveyor section having a conveyor belt and a plurality of rollers, or multiple conveyor sections, each having a conveyor belt and corresponding section of rollers.

In certain embodiments, the conveyor 20 can include a pair of sidewalls (not shown) that are adjustable in width and height and configured to guide the layers 61F, 62F, and 63F as they travel along a length of the machine. The sidewalls (not shown) can be configured to provide an additional layer 61F or 63F along a plane that is substantially perpendicular to the plane of the surface of the conveyor 20. Alternatively, the sidewalls (not shown) can be configured to fold one or both edges of the layers 61F and/or 63F at about 90-degrees to the plane of the surface of the conveyor 20, thereby encasing the multilayer structure entirely (or partially) in the layers 61F and/or 63F, such that the film 61F (or 63F) forms a top layer and, optionally, one or both sides of the multilayer structure, and the film 63F (or 61F) forms a bottom layer and, optionally, one or both sides of the multilayer structure, thereby encasing the entire multilayer structure in the films 61F and/or 63F.

The film material supply rolls 61, 63 and the hemp supply roll 63 can each be connected to a motor (not shown) that operates under controller of the controller 50. Each motor can be operated separately and individually, including speed, acceleration, deceleration, or stop/go. The film material supply rolls 61 and 63 can each include a roll of film material 61F and 63F, respectively, that forms the outer layers of the end product. The material supply roll 62 can include a roll of layered or cross-layered hemp fiber strands 62F.

In an alternative embodiment, the material supply roll 62 can be replaced by the strandsitioner 10 and/or strandsitioner 10′ discussed above, with respect to the embodiments depicted in FIGS. 1 and 3. In an embodiment, one or more material supply rolls 62 can be fed into the strandsitioner 10 and/or strandsitioner 10′. In those embodiments, the continuous layer 62F of hemp fiber strands can be supplied by the strandsitioner 10 and/or strandsitioner 10′.

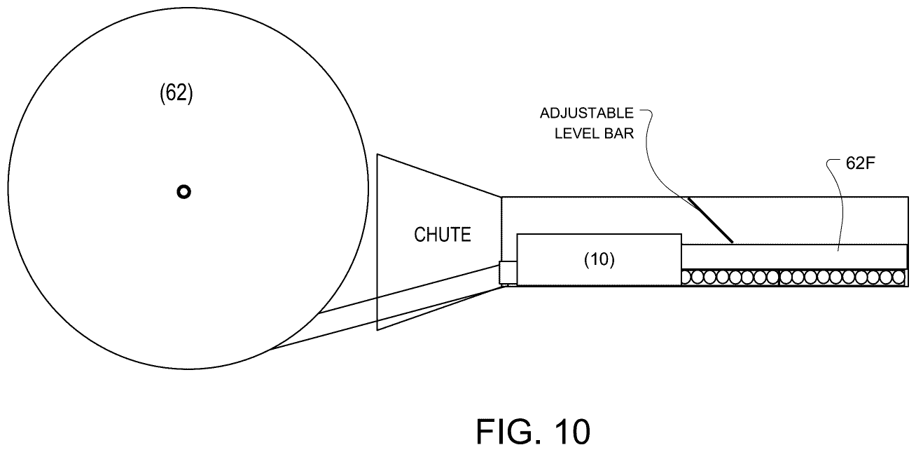

In an embodiment, the material supply roll 62 can be replaced by the aggregator 80 (shown in FIG. 2) or a chute that is configured to receive the hemp layer 62F from a material supply roll 62 and supply the hemp layer 62F to a strandsitioner 10, as shown in FIG. 10. As seen in FIG. 10, the layer of hemp output by the strandsitioner 10 can be pressed toward the conveyor by an adjustable level bar, after which it can be supplied to the conveyor 20 (for example, in FIG. 5) and placed atop of the film layer 61F (shown in FIG. 5).

In another embodiment, the material supply roll 62 can be a roller that is housed in the strandsitioner 10 (or aggregator 80) and configured to guide and place a layer of hemp fiber strands as the layer 62F onto the film material 61F. The hemp fiber strands can be guided and placed such that the layer 62F has a substantially constant width and height of hemp fiber strands that are placed atop of the film 61F and can be sandwiched between the films 61F and 63F. As noted above, the layer of hemp fiber strands can be interweaved or cross-linked for added strength.

The chute 68 can be optionally included in the apparatus 1 and configured to supply filler material on top of the layer 62F of hemp fiber strands from the roll 62. The filler material can include, for example, hemp, wood, plastic, metal, fiberglass, or recyclable materials. The apparatus can include an aggregator 69, which can be configured to resize filler material to a predetermined size, including a predetermined length, width, thickness, and shape. The aggregator 69 can include the aggregator 80, discussed above.

In an alternative embodiment, the apparatus 1 can include a second material supply roll 62 that is configured and positioned to place a second layer 62F of hemp material on top of the layer of filler material from the chute 68, before the film 63F is applied. In this embodiment, the apparatus 1 can include an additional applicator 65N, which can be located between the chute 68 and the second material supply roll 62.

In another embodiment, a plurality of chutes 68, material rolls 62, and applicators 65N can be included in series so as to add alternating layers of the hemp layer 62F and filler material layer. In this embodiment, the product can include three or more hemp material layers 62F and two or more layers of filler material.

The applicators 64N, 65N, and 66N can each include one or more nozzles that are configured to apply a fluid to a proximate surface, such as, for example the film material 61F from the roll 61, the hemp fiber strand layer 62F from the roll 62, and the filler materials from the chute 68, respectively. The one or more nozzles can include an array of nozzles positioned and configured to apply a substantially uniform thickness of fluid across the width of the film material 61F, hemp layer 62F, and filler material from the chute 68. Each of the applicators 64N, 65N, and 66N is connected, respectively, each fluid source 64FS, 65FS, and 66FS via a unique conduit and the associated control valve 64V, 65V, and 66V. The valves 64V, 65V, and 66V each operate under control of the controller 50.

The rollers R can be configured to guide and press: the film material 61F; the film material 61F and the hemp layer 62F; the film material 61F, the hemp material 62F, the filler material layer from the chute 68, and the film material 63F; and, the film material 61F, alternating layers of the hemp material 62F and filler material, and the film material 63F.

The press 40 can include a plurality of rollers 67R, any or all of which can be configured to apply a pressure of, for example, about 2,000 psi to 3,000 psi, or more, and temperatures greater than, for example, 350-degrees Fahrenheit.

In an alternative embodiment, the press 40 includes a pair of pressure plates (not shown) that are configured to squeeze (for example, about 2,000 psi to 3,000 psi, or greater) and heat (for example, 350-degrees Fahrenheit, or greater) the plurality of layers of material to form a hardened end-product.

The apparatus 1 can include a cutting unit 45 that cuts the hardened end-product to desired dimensions, such as, for example, the board 5 depicted in FIGS. 8 and 9. The cutting unit 45 can include, for example, one or more cutting blades, a laser, or other device capable of providing a clean cut, as will be understood by those skilled in the art.

Referring to FIG. 5, in various embodiments the apparatus 1 can include, for example, from left-to-right: a first paper/vinyl supply roll system comprising at least one roller 61 that is configured to supply a first outer layer material 61F for the final product; a first roller R configured to guide and position the film material 61F; a first nozzle assembly 64N configured to apply a tack agent to the first outer layer material 61F; one or more rollers R configured to guide and press the hemp fiber strand layer 62F against the film layer 61F; a second nozzle assembly 65N configured to apply an adhesive (for example, bioadhesive) to the hemp layer 62F; a chute configured to provide filler material; a third nozzle assembly 66N configured to apply an adhesive (for example, bioadhesive) to the hemp-filler composite material; a second paper/vinyl supply roll comprising at least one roller 63 that is configured to supply a second outer layer material 63F, opposite the first outer layer material for the final product; a hydraulic press 40 comprising at least one roller 67R (for example, 6 rollers), which can be configured to apply a pressure of 2,000 psi to 3,000 psi, or more, and temperatures greater than, for example, 350-degrees Fahrenheit; and a finalizing unit configured to size (for example, cut) and stack the resultant product 5.

In various embodiments, the film layers 61F or 63F can include a vinyl polymer, such as, for example, polyethylene (PE), polypropylene (PP), polystyrene (PS), polyvinyl chloride (PVC), polyvinyl acetate (PVAc), polyacrylonitrile, or the like.

In at least one embodiment, a second feeder line can be provided between the chute 68 and the roll 63, wherein the second feed line can include the strandsitioner 10 to cut and deliver, for example, perpendicularly oriented hemp fiber strands or filler material for increased strength.

The bioadhesives can include resins, binders, or biopolymers. The bioadhesives can include non-off gassing materials or formulations. The bioadhesive can include for example, biopolymers, biocopolymers, soy-based biopolymers (for example, soy protein), soy-based bioplastics, biodegradable polyester, bioplastics, cross-link agents, plasticizer agents, and the like.

The bioadhesive can include a plasticizer agent, such as, for example, glycerin, glycerin esters, polyglycoldiglycidyl ethers, alkylphosphate esters, polyethylene glycol, diethylene glycol, polypropylene glycol, polycaprolactone, triethyl citrate, acetyl trimethyl citrate, dibutyl phthalate, and the like; and a cross-link agent, such as, for example, an aluminum salt, a magnesium salt, a zirconium salt, boric acid, a borate salt, a phosphate salt, ammonium zirconium carbonate, potassium zirconium carbonate, oxidized starch, oxidized polysaccharides, oxidized hemicellulose, and the like.

The bioadhesive can include, for example, polyactic acid, polycaprolactone, polyhydroxybutyrate-hydroxybalerate copolymers, polyethylene terephthalate, polyhdroxyalkanoate, polyhydroxybutyrates, polyhydroxyvalerates, soy wax, glycerine, esters (for example, citric esters, cellulose esters, acetate, propionate, butyrate, benzoate, phthalate, and the like), and the like.

The biocomposite can include a bioadhesive and a plastic or thermoplastic. The plastic or thermoplastic can include, for example, a recycled plastic, recycled thermoplastic, polyethylene, polyethylene terephthalate (PET), high density polyethylene (HDPE), biodegradable polythene film, and the like.

The resin can include, for example, urea-formaldehyde, resorcinol-formaldehyde, phenol-formaldehyde, thermosetting phenol formaldehyde, epoxy, or other suitable adhesives that bind to hemp and other materials that can be included in the building product or material.

Referring to various embodiments discussed above, the aggregator 80 can include a motor, a rotor, a gear mechanism, a screw conveyor, and a plurality of cutting blades. The aggregator 80 can be configured to cut and shred hemp stalk to provide hemp fiber strands.

In the various embodiments discussed above, the conveyor 20 can be communicatively coupled to a dedicated driver in the controller 50, such as, for example, the conveyor driver (C-DRIVER) 150E seen in FIG. 6. The C-DRIVER 150E can be configured to transmit control signals to each conveyor 20 in the apparatus 1 to control operation of the conveyor, including transport speed, transport rate, and transport direction of each section of the conveyor 20, separately.

The strandsitioner 10 can be configured to communicate with the controller 50 and operate under control of a dedicated driver in the controller 50. As seen in FIG. 6, the dedicated driver can include a strandsitioner driver (S-DRIVER) 150B that is configured to transmit control signals to the strandsitioner 10 to operate, for example, the motor and cutting blades. In an embodiment, the S-DRIVER 150B can be configured to send control signals to the strandsitioner 10 to cut the hemp stalks at a determined speed, rate, or direction.

FIG. 6 depicts a block diagram of an embodiment of the controller 50 constructed according to the principles of the disclosure. In the embodiment, the controller 50 includes a processor 110, a storage 120, an input-output (IO) interface 130, a network interface 140, a bus, and a plurality of drivers 150A to 150E. Each component in the controller 50 can be arranged to connect to the bus. The controller 50 can include one or more devices such as, for example, a transmitter, a receiver, a transceiver, a modulator, a demodulator, a modem, an encoder, a decoder, or a codec.

The processor 110 can include a computing device, such as, for example, any of various commercially available graphic processing unit devices. Dual microprocessors and other multi-processor architectures can be included in the processor 110. The processor 110 can include a central processing unit (CPU), a graphic processing unit (GPU), a general-purpose GPU (GPGPU), a field programmable gate array (FGPA), an application-specific integrated circuit (ASIC), or a manycore processor.

The processor 110 can be arranged to process instructions for execution within the controller 50, including instructions stored in the storage 120. The processor 110 can process instructions to display graphical information for a graphic user interface (GUI) on an external input/output device, such as a display device coupled to the IO interface 130 or the high-speed interface.

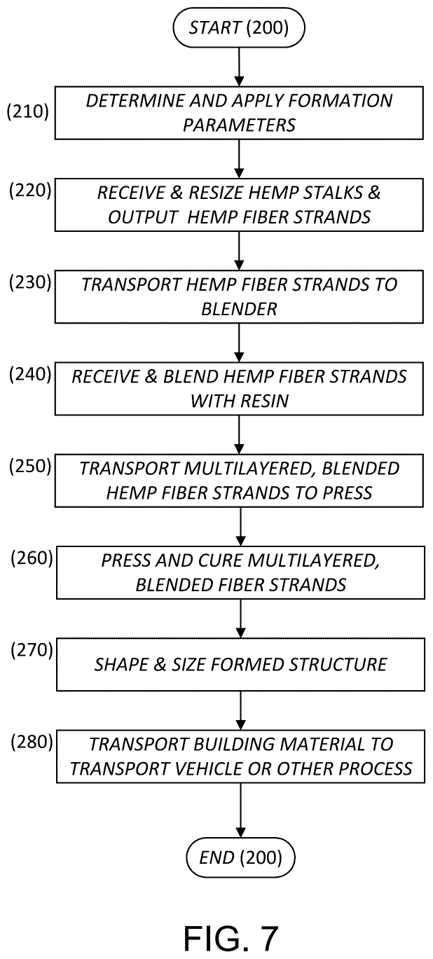

The storage 120 can include a read-only-memory (ROM) 120A, a random-access-memory (RAM) 120B, and a hard-disk-drive (HDD) 120C. The storage 120 can include a non-transitory computer-readable medium that can hold executable or interpretable computer program code or instructions that, when executed by the processor 110, can cause the steps, processes and methods in this disclosure to be carried out, including each of the Steps 210 to 280 in the process 200 (shown in FIG. 7).

A basic input/output system (BIOS) can be stored in the non-volatile memory, which can include, for example, the ROM 120A. The ROM 120A can include an erasable programmable rea-only memory (EPROM) or an electrically erasable programmable read-only memory (EEPROM). The BIOS can contain the basic routines that help to transfer information and instructions between the components 110-150 in the controller 50, such as during start-up.

The RAM 120B can include a dynamic random-access memory (DRAM), a synchronous dynamic random-access memory (SDRAM), a static random-access memory (SRAM), a non-volatile random-access memory (NVRAM), or another high-speed RAM for caching data.

The HDD 120C can include, for example, an enhanced integrated drive electronics (EIDE) drive or any suitable hard disk drive for use with big data. The HDD 120C can be configured for external use in a suitable chassis (not shown). The HDD 120C can be connected to the bus by a hard disk drive interface (not shown) and an optical drive interface (not shown), respectively. The hard disk drive interface (not shown) can include a Universal Serial Bus (USB) (not shown), an IEEE 1394 interface (not shown), or any other suitable interface for external applications.

The storage 120 can provide nonvolatile storage of data, data structures, and computer-executable code or instructions. The storage 120 can accommodate the storage of any data in a suitable digital format. The storage 120 can include one or more computer resources that can be used to execute aspects of the architecture described herein.

One or more computer resources can be contained in the storage 120, including, for example, an operating system (not shown), one or more application programs (not shown), one or more APIs, and program data (not shown). The APIs can include, for example, JSON APIs, XML APIs, Web APIs, SOAP APIs, RPC APIs, REST APIs, or other utilities or services APIs. Any (or all) of the computer programs can be cached in the RAM 120B as executable sections of computer program code.

The IO interface 130 can be arranged to receive commands and data from, for example, the processor 110 or a communicating device (not shown) located external to the controller 50, which can be interacted with by a user. The IO interface 130 can be arranged to connect to or communication with one or more input/output devices (not shown), including, for example, a keyboard (not shown), a mouse (not shown), a pointer (not shown), a microphone (not shown), a speaker (not shown), or a display (not shown). The received commands and data can be forwarded from the IO interface 130 as instruction and data signals via the bus to any computer device in the system 1 (shown in FIG. 1).

The network interface 140 can be connected to a network. The controller 50 can connect to one or more communicating devices in the system 1 (shown in FIG. 1), including, for example, a communicating device in any of the strandsitioner 10, conveyor(s) 20, blender 30 or a facing sheet (61 or 63), or press 40, via the network interface 140 communicating with each communicating device over a communication link.

The network interface 140 can be connected to the network via one or more communication links. The network interface 140 can include a wired or a wireless communication network interface (not shown) or a modem (not shown). When used in a local area network (LAN), the controller 50 can be connected to the LAN network through the wired or wireless communication network interface; and, when used in a wide area network (WAN), it can be connected to the WAN network through the modem. The network can include a LAN, a WAN, the Internet, or any other network. The modem (not shown) can be internal or external and wired or wireless. The modem can be connected to the bus via, for example, a serial port interface (not shown).

The controller 50 includes a suite of drivers, including: a driver (F-DRIVER 150A) that generates and sends supply control signals to each of the material supply sources (for example, rolls 61, 62, 63, or chute 68) to supply the materials 61F, 62F, 63F, and filler materials; a driver (S-DRIVER 150B) that generates and sends strandsitioner control signal to the strandsitioner 10 (and/or aggregator 80) to operate the cutting unit and/or compression unit 70 to cut, shred, or dice hemp and/or to compress the hemp; a driver (B-DRIVER 150C) that generates and sends blend control signals to the fluid supply sources 64FS, 65FS, 66FS (shown in FIG. 5), the valves 64V, 65V, 66V (shown in FIG. 5), or the blender 30 (shown in FIG. 1); a driver (P-DRIVER 150D) that generates and sends pressure and heat control signals to the press 40 to apply a predetermined pressure and/or temperature to the layers 61F, 62F, filler, and 63F of material; and a driver (C-DRIVER 150E) that generates and sends motor control signals to operate the one or more conveyor sections of the conveyor 20. The P-DRIVER 150D can also generate and send cutting control signals to a cutting unit 45 to cut the pressed material into a predetermined shape and size. Each driver can be operated under control of the processor 110 to generate and send control signals to the respective, associated component in the apparatus via an associated communication link.

The apparatus 1, under operation of the controller 50, can form hemp-based structures such as, for example, planar sheets of building material. The planar sheets can be sized, for example, by the press 40 or another device located downstream of the press 40, to a predetermined width, height and thickness, such as, for example, a 4-foot by 8-foot planar board having a thickness of ¼ inch, ½ inch, ⅝ inch, ¾ inch, 1 inch, or the like.

The apparatus 1 can produce building material that meets a variety of issues facing current building standards. For instance, the hemp-based building materials produced by the apparatus 1 can be light-weight, mold resistant, and durable, while reducing energy consumption costs and the creation of secondary pollutants compared to wood-based products. The hemp-based building materials of the instant disclosure can be configured to absorb and release moisture without deteriorating. The apparatus 1 can be configured to add (for example, via the blender 30) a fire-retardant material to provide a hemp-based building material that is non-flammable, making the material ideal for building applications such as, for example, in walls and roofs of building structures.

In various embodiments, the hemp fiber strands can be blended with, in addition to the resin materials, plastic, fiberglass, wood, metal, and other synthetic or naturally occurring materials in, for example, the blender 30 (shown in FIG. 1).

FIG. 7 shows a block diagram of an embodiment of a manufacturing process 200 that can be performed by the apparatus 1 (for example, shown in FIGS. 1, 3, or 5). The controller 50 (shown in FIG. 6) can be configured to perform the process 200 by operation of the processor 110. Initially, at Step 210, formation parameters can be determined and applied to generate and send control signals to each of the components in the apparatus 1, including, for example, the strandsitioner 10, conveyor 20, blender 30, press 40, compression unit 70 (shown in FIG. 1) or the material rolls 61, 62, 63, applicators 64N, 65N, 66N, valves 64V, 65V, 66V, fluid supply sources 64FS, 65FS, 66FS, chute 68, rollers R and conveyor 20 (shown in FIG. 5).

In various embodiments, the formation parameters can include any or all of the following: a speed value (for example, in meters-per-second); an acceleration/deceleration rate value (for example, in meters-per-second²); a temperature value (for example, in degrees Centigrade); a pressure value (for example, in Pascal); a volume value (for example, in cubic meters); and a volume rate (for example, in meters³-per-second). The formation parameters can be used by the suite of drivers to control: temperature, pressure, hemp, resin, and any other materials input into the apparatus; the speed, rate, and direction of transport by each of the conveyor sections in the conveyor 20; the speed, rate, and direction of cutting in the strandsitioner 10; the speed, rate, and direction of layering of the hemp fiber strands (for example, at the output of the strandsitioner 10, or in the blender 30); the temperature, speed, rate, and direction of application of resin to the hemp fiber strands (for example, in the blender 30, or the applicators 64N, 65N, 66N); the speed, rate, temperature, and pressure applied to the multilayered blended hemp fiber strands (for example, in the press 40); and the shape, size, and dimensions for cutting the formed structure (for example, in the press 40).

Referring to the embodiment of the apparatus 1 in FIG. 1, in response to control signals received from the controller 50, hemp stalks are received at the input 15 (or, optionally, the compression unit 70 and then the input 15) and provisioned to the cutting blades in the strandsitioner 10, where the hemp stalks are cut to hemp fiber strands (Step 220). The hemp fiber strands are then transported, via the conveyor 20, to the blender 30 (Step 230), where the hemp fiber strands are oriented and layered, and the input resin applied to the hemp fiber strands (Step 240). The layers of hemp fiber strands can be cross-linked and/or interwoven, with each layer of fibers being positioned substantially perpendicular to each adjoining layer of fibers.

The multilayered, blended hemp fiber strands are then transported, via the conveyor 20, to the press 40 (Step 250), where the hemp fiber strands are pressed and heat-cured to form a solid structure (Step 260). As noted earlier, the press 40 can include rollers, pressure plates, or any combination thereof. Per the formation parameters, the formed structure can be shaped and sized by cutting blades in the press 40 and output as the building product or material (Step 270). The building product or material can then be transported by the conveyor 20 to a transport vehicle, finishing process, or other process (Step 280).

In various embodiments, the blender 30 (shown in FIG. 1) is configured to receive one or more film or sheet materials (for example, 61F, 62F, 63F shown in FIG. 5) on which (or between which) the multilayered blended hemp fiber strands can be positioned before being transported to the press 40. The film/sheet material can comprise filler materials or hemp fibers. In various embodiments, the film material (for example, 61F or 63F, shown in FIG. 5) can be optional and need not be included, for example, with certain liquid-resin applications. In other embodiments, the film/sheet material can be included to facilitate melting/bonding with, for example, recycled plastics such as plastic bags, or the like.

In certain embodiments, press 40 can include a plurality of presses. The presses can be configured in series or cascade, with the first two (upstream) presses being hot presses and the third (downstream) press being a cold press. The instant disclosure provides a continuous roller system that substantially exceeds production and efficiency to that of state-of-the art machinery.

The terms “a,” “an,” and “the,” as used in this disclosure, means “one or more,” unless expressly specified otherwise.

The term “backbone,” as used in this disclosure, means a transmission medium or infrastructure that interconnects one or more computing devices or communicating devices to provide a path that conveys data packets or instructions between the computing devices or communicating devices. The backbone can include a network. The backbone can include an ethernet TCP/IP. The backbone can include a distributed backbone, a collapsed backbone, a parallel backbone or a serial backbone.

The term “bus,” as used in this disclosure, means any of several types of bus structures that can further interconnect to a memory bus (with or without a memory controller), a peripheral bus, or a local bus using any of a variety of commercially available bus architectures. The term “bus” can include a backbone.

The term “communication link,” as used in this disclosure, means a wired and/or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, GSM voice calls, SMS, EMS, MMS messaging, CDMA, TDMA, PDC, WCDMA, CDMA2000, GPRS, WiFi, WiMAX, IEEE 802.11, DECT, 0G, 1G, 2G, 3G, 4G, 5G or 6G cellular standards, or Bluetooth. A communication link can include, for example, an RS-232, RS-422, RS-485, or any other suitable interface.

The terms “computer” or “computing device,” as used in this disclosure, means any machine, device, circuit, component, or module, or any system of machines, devices, circuits, components, or modules, which can be capable of manipulating data according to one or more instructions, such as, for example, without limitation, a processor, an application specific integrated circuit (ASIC), a field programmable gate array (FPGA), a microprocessor (μP), a central processing unit (CPU), a graphic processing unit (GPU), a general purpose computer, a super computer, a personal computer, a laptop computer, a palmtop computer, a notebook computer, a smart phone, a mobile phone, a tablet, a desktop computer, a workstation computer, a server, a server farm, a computer cloud, or an array of processors, ASICS, FPGAs, μPs, CPUs, GPUs, general purpose computers, super computers, personal computers, laptop computers, palmtop computers, notebook computers, desktop computers, workstation computers, or servers. A computer or computing device can include hardware, firmware, or software that can transmit or receive data packets or instructions over a communication link. The computer or computing device can be portable or stationary.

The term “computer-readable medium,” as used in this disclosure, means any storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “Cloud,” which includes a distribution of files across multiple (e.g., thousands of) memory caches on multiple (e.g., thousands of) computers. The computer-readable medium can include magnetic discs, optical disks, memory, or Programmable Logic Devices (PLDs).

Various forms of computer readable media can be involved in carrying sequences of instructions to a computer. For example, sequences of instruction (i) can be delivered from a RAM to a processor, (ii) can be carried over a wireless transmission medium, and/or (iii) can be formatted according to numerous formats, standards or protocols, including, for example, WiFi, WiMAX, IEEE 802.11, DECT, 0G, 1G, 2G, 3G, 4G, or 5G cellular standards, or Bluetooth.

The terms “including,” “comprising” and variations thereof, as used in this disclosure, mean “including, but not limited to,” unless expressly specified otherwise.

The term “network,” as used in this disclosure means, but is not limited to, for example, at least one of a personal area network (PAN), a local area network (LAN), a wireless local area network (WLAN), a campus area network (CAN), a metropolitan area network (MAN), a wide area network (WAN), a metropolitan area network (MAN), a wide area network (WAN), a global area network (GAN), a broadband area network (BAN), a cellular network, a storage-area network (SAN), a system-area network, a passive optical local area network (POLAN), an enterprise private network (EPN), a virtual private network (VPN), the Internet, or any combination of the foregoing, any of which can be configured to communicate data via a wireless and/or a wired communication medium. These networks can run a variety of protocols, including, but not limited to, for example, Ethernet, IP, IPX, TCP, UDP, SPX, IP, IRC, HTTP, FTP, Telnet, SMTP, DNS, ARP, ICMP.

The term “server,” as used in this disclosure, means any combination of software and/or hardware, including at least one application and/or at least one computer to perform services for connected clients as part of a client-server architecture. The at least one server application can include, but is not limited to, for example, an application program that can accept connections to service requests from clients by sending back responses to the clients. The server can be configured to run the at least one application, often under heavy workloads, unattended, for extended periods of time with minimal human direction. The server can include a plurality of computers configured, with the at least one application being divided among the computers depending upon the workload. For example, under light loading, the at least one application can run on a single computer. However, under heavy loading, multiple computers can be required to run the at least one application. The server, or any if its computers, can also be used as a workstation.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described herein may be performed in any order practical.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method for manufacturing a hemp-based building product or material, the method comprising:
forming a hemp-based multilayer structure, including
applying a first solution to a first film layer,
applying a hemp strand layer to the first film layer with the first solution,
applying a second solution to the hemp strand layer,
applying a filler material layer to the hemp strand layer with the second solution,
applying a third solution to the filler material layer,
applying a second film layer to the filler material layer with the third solution;
pressing the formed hemp-based multilayer structure; and
heating the formed hemp-based multilayer structure.

2. The method in claim 1, wherein at least one of the first film layer and the second film layer comprises a vinyl polymer or a paper layer.

3. The method in claim 1, further comprising:
applying at least one additional filler material layer before applying the second film layer.

4. The method in claim 1, further comprising:
applying at least one additional hemp strand layer.

5. The method in claim 4, wherein the at least one additional hemp strand layer comprises hemp fiber strands oriented at an angle with respect to hemp fiber strands in the hemp strand layer.

6. The method in claim 5, wherein the angle is about 90-degrees.

7. The method in claim 1, wherein the first solution comprises a tacky solution.

8. The method in claim 1, wherein the second solution comprises an adhesive solution.

9. The method in claim 8, wherein the adhesive solution comprises a bioadhesive.

10. The method in claim 1, wherein the third solution comprises an adhesive solution.

11. The method in claim 10, wherein the adhesive solution is a bioadhesive.

12. An apparatus for manufacturing a hemp-based building product or material, the apparatus comprising:
a first material supply unit configured to supply a first film layer;
a second material supply unit configured to supply a hemp strand layer and position the hemp strand layer on the first film layer;
a third material supply unit configured to supply a filler material layer and position the filler material layer on the hemp strand layer;
a fourth material supply unit configured to supply a second film layer and position the second film layer on the filler material layer; and
a press configured to receive and apply a pressure to the first film layer, the hemp strand layer, the filler material layer, and the second film layer,
wherein the press is further configured to heat the first film layer, the hemp strand layer, the filler material layer, and the second film layer.

13. The apparatus in claim 12, further comprising:
a first applicator unit configured to apply a first solution to the first film layer;
a second applicator unit configured to apply a second solution to the hemp strand layer; and
a third applicator unit configured to apply a third solution to the filler material layer.

14. The apparatus in claim 12, wherein the press includes at least one of a pressure plate and a plurality of rollers.

15. The apparatus in claim 12, wherein at least one of the first film layer and the second film layer comprises a vinyl polymer or a paper layer.

16. The apparatus in claim 12, further comprising at least one additional material supply unit that is configured to supply an additional hemp strand layer and position the additional hemp strand layer on said hemp strand layer or the filler material layer.

17. The apparatus in claim 16, wherein the at least one additional material supply unit comprises a material supply unit that is configured to supply an additional filler material layer and position the additional filler material layer on the additional hemp strand layer.

18. The apparatus in claim 16, wherein the additional hemp strand layer comprises hemp fiber strands oriented at an angle with respect to hemp fiber strands in said hemp strand layer.

19. The apparatus in claim 18, wherein the angle is about 90-degrees.

20. The apparatus in claim 13, wherein:
the first solution comprises a tacky solution;
the second solution or the third solution comprises an adhesive solution; or
the adhesive solution comprises a bioadhesive.
